(19) United States
(12) Patent Application Publication
(10) Pub. No.: US 2002/0087574 A1
(43) Pub. Date: Jul. 4, 2002

(54) Method for automating inspecting labels

(76) Inventors: Terrence P. Walsh, Cedars, PA (US); Dawn A. Wright, Downingtown, PA (US); Frank Hetzel, Lansdale, PA (US)

Correspondence Address: SMITHKLINE BEECHAM CORPORATION, Corporate Intellectual Property - UW2220, P.O. Box 1539, King of Prussia, PA, 19406-0939, US

(21) Appl. No.: 09/737,358

(22) Filed: Dec. 15, 2000

(51) Int. Cl. G06F 7/00

(52) U.S. Cl. 707/104.1

(57) ABSTRACT

This invention relates to a method for inspecting hard-copy container labels which carry alpha-numeric data using an sensing device which captures information from the label and compares that data electronically against a pre-define set of parameters.

### AREA OF THE INVENTION

This invention relates to a method for inspecting study-critical hard-copy labels using a sensing device that captures information from the label and compares that data against a pre-defined set of parameters. It is particularly useful for inspecting labels that carry information in an alphanumeric format.

### BACKGROUND

Proof of efficacy and safety of new drugs requires testing in human subjects. This is usually achieved by carrying out controlled clinical trials with drugs. The details and plan of conducting these clinical trials are recorded in the study protocol. These are generally written by the R&D clinical staff and contain the design, dosage form, strengths and dosing regimen for an investigational drug study. Based on the study protocol, a packaging scheme is created. After this scheme is agreed labels are designed and undergo review until a final design is agreed. Labels are then printed for the study using a master template and inspected. Once the labels are inspected, they are released to the operations unit and are applied to the containers.

Labels are strenuously controlled by many regulations: Standard operating procedures, guidelines—Good Manufacturing Procedures and Good Clinical Procedures, country and Authority regulations, etc. The US Food & Drug Administration (FDA) reports that most product recalls involve label issues. The current FDA guidelines require a two hundred percent inspection of labels if humans perform the inspection. The FDA only requires a one hundred percent inspection if the inspection process is automated. The types of phenomenon that are generally found during inspection are print quality issues (smudges, smears, missing print etc), missing labels and incorrect counts. Labels can also be in languages other than English, which complicates inspection even further. In blinded clinical drug studies, a label usually has a unique identifier. The 5-6 digit number needs to be checked during the inspection against the original record of the numbers.

Quality inspection work is typically done manually. This approach uses a two hundred percent inspection for all study/patient-specific labels. While a two hundred percent manual inspection is used there are limitations in it that could lead to mistakes and omissions. There is a need for an automated inspection process to enhance throughput and address the limitations of the manual process.

Herein there is provided an automated system that allows one to inspect quickly, easily and reliably printed label content. It also allows the user to obtain easily and accurately data on the inspected labels (number of labels inspected, planned duplicate labels etc). The advantage of the method described herein is that it eliminates the second inspection step required by the manual process.

### SUMMARY OF THE INVENTION

A method for inspecting by machine the alpha-numeric data on labels using an electronic sensor programmed to capture data from the labels and compare the captured data against a master template and thus identifying aberrant labels, wherein the method comprises:

in optional order:

a) loading a master label template data file in computer-readable form onto a label reading device or creating thereon same; and

b) loading printed labels into said device;

and thereafter scanning each label or a selected subgroup of labels using a reader in the device wherein the data read by the reader is compared against the template data file and wherein the device has a mechanism for identifying a label which is read as not matching the parameters contained in template data file.

This invention also relates to a device that employs the method described herein and a method that uses, but is not limited to, the label design of FIG. 2.

### DESCRIPTION OF THE FIGURES

FIG. 1 is a block flow diagram of the method used in this process.

FIG. 2 is an illustration of a useful label.

FIG. 3(a)-3(c) are different views of a vision-recording device.

### DETAILED DESCRIPTION OF THE INVENTION

This method can be used to inspect hard-copy labels for accuracy and the completeness of data recordation on the label. While it is contemplated that most labeling will involve visible alpha-numeric data, this methodology could also be applied to bar-coded labels or labels which contain information residing on the label in some other form which is detectable by a device that can capture non-visible electromagnetic energy or magnetically encoded information. The system described herein provides one with a means to inspect label content and compare it against an approved master label content, or template, and against a list of container numbers. It is not intended to make corrections to a label or apply labels, only to identify aberrant labels.

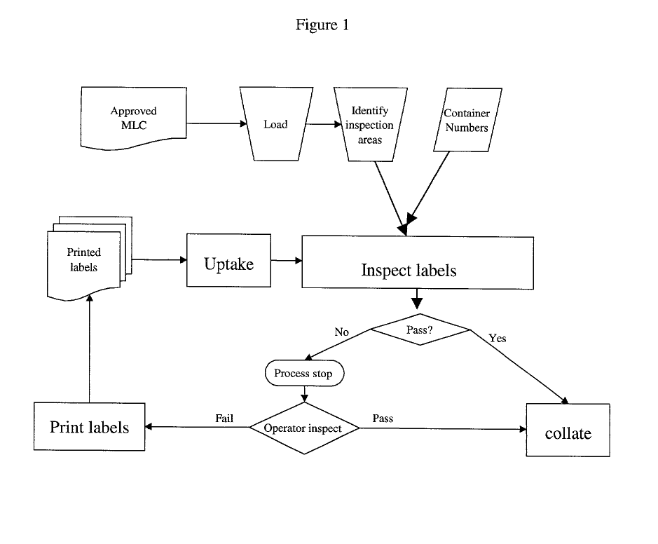

An overview of the method is illustrated in the flowchart in FIG. 1.

A master label copy (MLC in FIG. 1), or template, is first created from data that was loaded into a computer to be used as the reference file for controlling the label printer. A label image representing this file will be used after printing as the reference data file during the label inspection step as well. This template can be comprised of text, image(s) or mixed text and image data. A bitmap (.bmp) format is a preferred data file type to use for setting up the master label template. Other formats could be used; for example a tagged image format (.tif) or Adobe Acrobat's portable document format (.pdf) image formatting.

In the steps set out in FIG. 1, there is also provided an option to build into the inspection operation directions to do a partial inspection of the label during the inspection process.

Another option is that the template will be capable of merging data from another file into the basic label design and content. Herein the box labeled as “Container Numbers” illustrates that in FIG. 1. In drug clinical trials it is often necessary to generate several labels that repeat a set of data, e.g., study number but with a numerical identifier which distinguishes between labels. An example of this is where a patient is to receive five different vials in series at a pre-determined time, information on the label must reflect by some means. In this example five labels would be generated each with a different number to distinguish one from the other.

Labels are then prepared under the control of the label template. An illustration of a finished label is that of printing with ink or a xerographic process on paper or a paper-like substrate. This type of printing provides labels that can be scanned by a sensing device which can detect the distribution of material on the substrate using a device that can record data in the electromagnetic spectrum. A preferred technique is to use material which creates a pattern that can be discerned by the human eye since it has application in the medical field and involves a human being able to see and recognize the patterns on the label as meaningful information. But in fact data could be etched, implanted or deposited onto the substrate, using material which is readable by a device which can capture electromagnetic radiation outside the visible spectrum, or only be seen after being excited such as can be achieved by shining a florescent lamp on the label. Alternatively, the material placed on the hard-copy substrate could contain magnetic particles. Combinations of these materials can be used in preparing labels.

By way of example, physically, most labels have three components: Paper (the label proper), adhesive and backing. The paper can be made up of a single layer or can be a combination of multiple layers including plastics, different weights of paper etc. This is the medium that the ink is printed onto.

The adhesive of a label is the “glue” that adheres the paper to the container or ultimate destination of the label. The glue can be permanent or temporary; with differing degrees of each. The adhesive is on one side of the label.

The backing is what the paper label is attached to for handling and printing. The backing gives the label a large, fixed ingredient that holds the labels in alignment for printing. The backing is also made of paper but is coated with a wax-like substance that allows the easy removal of the label and adhesive. The backing can be rolled or fan-folded (accordion-folded).

Labels used in clinical trials usually are referred to as 1 part, 2 part or 3 part. A one-part label does not have any perforations and is a single panel. The entire label is attached to the container and is not expected to be removed. This label is generally used in open label studies. The adhesive is generally permanent and includes static text:

A two-part label has two-label panels- there is a perforation between the two panels. The first panel has all the information and is permanently attached to the container. The second panel has abbreviated information and can be permanent adhesive with a small piece of backing attached (to prevent it from attaching to the container) or temporary adhesive. The second panel is removed at the time of dispensing and attached to patient records. This label is primarily used for blinded studies and usually includes a unique identifier. The typical layout for this label is side by side as illustrated in FIG. 1.

A three-part label has two panels, but it also includes overlay on the second panel. This label is exclusively used for blinded studies and almost always includes a unique identifier. This overlay is opaque ink and covers information about the contents of the container. The overlay can be removed by swabbing it with a solvent in which the dried opaque ink is soluble, such as an alcohol, to remove it and view the content description.

The label is generally all text, but can be a combination of graphics and text. Examples of what can be included on a label are:

compound

protocol

drug name

drug batch number

drug strength

visit information

expiration date

country specific regulations

patient identifier

container number/code

contents

storage conditions

blinding panel

container identification

Clinical medication labels can be applied by hand or automatically by equipment that is designed for this function. When applying labels by hand, the presentation of the label (roll or fan fold) or orientation of text (vertical or horizontal) is not an issue. Hand application is very resource intensive and the elegance of the final product can be erratic due to misalignment of the label.

If the labels are to be applied by machine, the labels must be presented on a roll and the labels must be vertically oriented or end to end as opposed to top to bottom. The advantages of machine application are a vast increase in the number of labels applied in a given time period and accuracy of alignment.

Preparing labels for a roll can present problems with orientation and printing especially if preparing blinded multi-panel labels. There was no currently available multiple panel vertical labels on a roll. Also, the label printing applications had difficulty in printing rotated text.

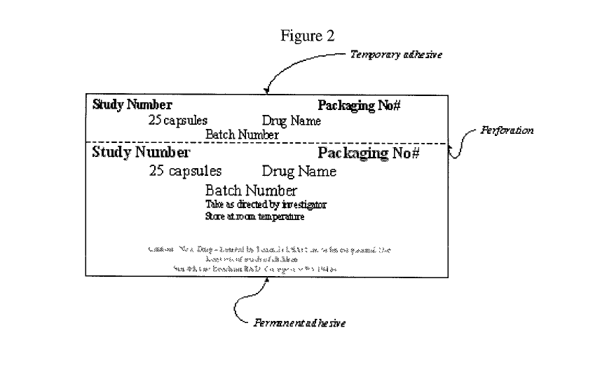

Clinical medication labels differ from commercial medication labels in that the clinical labels involve smaller quantities, have changing text and use a unique identifier on each label. The clinical labels that utilize a multiple panel design were only available in fan fold. The single panel roll labels contained only static text. Multiple panel labels are only available on a fanfold backing. A new label has been created which is formatted in the vertical position on a roll label and has an upper and a lower panel (as opposed to side by side) as illustrated in FIG. 2.

After labels are printed the master label image is loaded onto a reading device or the image file is made available electronically to that device. This device is programmed to read the labels and compare that data against the master label data file. In addition, areas are identified on the label that are to be inspected for quality of print (smudges etc). These areas will have tolerance levels associated with them. The tolerance levels can be made tighter (accept less quality-related print issues) or looser (accept more quality-related print issues). Another area on the label is identified as the location of the container numbers. The numbers in this area are to be read using optical character recognition and compared to a list of container numbers.

The operator then loads the machine with the labels to be inspected and begins the inspection process. An automatic “stop” command can be built into the system and if one is, it will be activated by detection of a label which gives a reading that does not match the master template data file parameters. The machine will stop when, during the inspection of the label, the label is determined not to pass the print quality inspection. At this point the operator will be able to override the decision or remove the label. The inspection process will not be able to be over-ridden if the machine cannot read the container number(s) or if the container number read is out of range. After the labels have been inspected, the operator will print a report with statistics for the run.

More specifically, one example of the use of this invention is one where a video camera is used to capture an image of a label and transfer this image to a computer. The computer will be programmed to compare the camera image with the image loaded into memory and determine differences in some preset parameter(s), and accept or reject the label based on a pre-set tolerance limit. An example of image-difference detection are that of overlaying the pixels in the image captured by the detector with a pixel-based image of the master template, detecting differences in pixel overlap for the two images, and only rejecting a given label if the number of pixels which do not overlap the pre-recorded template pixels exceed a pre-set number, the so called tolerance limit. It is called optical character verification or OCV by some. This technique can be applied to some or all of the label area that is being checked. In a preferred embodiment, this technique is used to check for inaccuracies in just the patient data section of the label, not the bottle number.

In addition to checking for image overlap of alphanumeric data, the system can be programmed to identify random, unstructured pixel data in the scanned image. This option provides a means for identifying labels that have accurate data printed accurately on them, but which have some other flaw such as an ink spot or a line across the label in some fashion. These so-called blobs can render a label unsatisfactory for use. Again, a tolerance limit for such random images, in terms of pixels or some other measure, is pre-set prior to running the labels through the scanning device. In addition, the number of blobs can be measured and labels kicked out if there are to many blobs.

Tolerance limits for pixel-base image overlap and blob detection is within the skill of the artisan. They can be set at the same level for both techniques, or they can be different. By way of further example, if labels are printed on a device that has a high dots-per-inch capability, the tolerance limits for the image overlap may be set fairly stringently. It will be expected that a laser printer will give cleaner, more precise print than will an inkjet printer, so tolerance limits for pixel overlap and blobs can be set to a tighter specification.

In actual practice, as the machine runs, an image of each label is captured and subtracted from the master image. The subtraction between the images is captured (black ground/white subtraction image). Examples of tolerance limits for overlapped images and blobs are:

Pixel Analyzer: Upper Limit—300 white pixels; lower limit—0.

Blob Analyzer: Upper Limit—5000 [(mm/pixel)²]; lower limit—0.

Number of Blobs: Upper Limit—2; lower limit—0.

A preferred embodiment uses OCR to detect variations and mistakes in a label. It is particularly useful when applied to a variable in the label such as detecting an incorrect number on a particular bottle where that bottle is one in a series of numbered bottles. To illustrate, if a given study protocol calls for 10 bottles to be issued to patient Jones, ten consecutive labels must be numbered 00001” through “00010” consecutively, but the other data on each bottle will remain the same. Since this is a variable image, OCR (or another character-reading technology), will be more useful that pixel-matching techniques since it can be programmed to recognize a range of values in a given image. And the computer receiving the scanned image can be programmed to select one specific area of the image, convert that part of the scanned image to text, and check that text against a text data file to insure the image on the label represents a valid numerical value for that label set.

SVResearch, Inc, of Harrisburg, Pa., USA, manufactures an example of a machine that can be used for inspecting labels. A preferred device is the one sold by SVResearch as under the name SVReader™ and software marketed by this company under the name SVFocus™. That device uses optical character recognition (OCR) and optical character verification (OCV) to confirm the proper printing of text on a substrate. Different views of the actual device are provided in FIG. 3 (“Overall Assembly” drawing). A PC is used to control the operation of the reader. The selection of this part of the equipment is left up to the practitioner but an Intel chip-based PC, for example, or a Sun Microsystems workstation will likely provide a satisfactory systems control device. Operating system software can be any current OS as exemplified by Microsoft's Windows NT, UNIX, or Linux software. In a preferred approach, the template file will reside on the computer controlling the optics of the reader; it will be an Intel-containing PC running Windows NT v 5.0 or higher.

The foregoing descriptions and characterizations are provided as examples of the operation of this invention. As such, these descriptions and characterizations are not to be read as limiting the scope of what is reserved to the inventors. That is to be determined solely by reference to the claims appended hereto.

What is claimed is:

1. A method for inspecting by machine the alpha-numeric data on labels using an electronic sensor programmed to capture data from the labels and compare the captured data against a master template and thus identifying aberrant labels, wherein the method comprises:
in optional order:
a) loading a master label template data file in computer-readable form onto a label reading device or creating thereon same; and
b) loading printed labels into said device;
and thereafter scanning each label or a selected subgroup of labels using a reader in the device wherein the data read by the reader is compared against the template data file and wherein the device has a mechanism for identifying a label which is read as not matching the parameters contained in template data file.
